(19) United States
(12) Patent Application Publication
(10) Pub. No.: US 2007/0025828 A1
(43) Pub. Date: Feb. 1, 2007

(54) Anti-disengaged screw device

(76) Inventor: Ming-De Wu, Taipei (TW)

Correspondence Address: G. LINK Co., LTD, 3550 Bell Road, Minooka, IL, 60447, US

(21) Appl. No.: 11/193,137

(22) Filed: Aug. 1, 2005

(51) Int. Cl. F16B 23/00

(52) U.S. Cl. 411/402

(57) ABSTRACT

An anti-disengaged screw device includes a stem member and a nut member. The stem member is composed of a screw rod section and a disk head and a plurality of exertion wedges are disposed on the disk head as an exertion point of a torsion force. The nut member provides an axial hole and a deep countersink for the screw rod section passing through the axial hole and the disk head being received in the countersink. A lock configuration is formed between the circumference of the countersink and the exertion wedges for being inserted and turned with a key arm, which providing wedge recesses and an annular lock head corresponding to the lock configuration, such that it is capable of preventing from being inserted in and turned with an ordinal tool directly and protecting the screw device from being disassembled.

### BACKGROUND OF THE INVENTION

1. Field of the Invention

The present invention is related to an anti-disengaged screw device and particularly to a screw device with a special structure in which a spot for exerting a torsion force is arranged different from the conventional way to prevent from being disassembled simply with ordinary tools.

2. Brief Description of the Related Art

It is known that screws are widely used in our daily lives to assemble apparatus such as electronic appliances, various machinery devices, transportation tools or anti-burglar devices.

Generally, the screws are classified into two categories, character head screws and polygon head screws. The character type head screws further have such as I-type screws and cross type head screws. The polygon head screws further have such as hexagon socket head screws and hexagon head screws. The conventional screws are designed to be detachably fastened with ordinary tools such as character type tip screwdrivers or polygon head spanner regardless what types heads of the screws for being exerted a turning force are. The different type heads of the screws means different force exertion spots available for the users to choose and meet their specific needs. For instance, the character type head screws provide less force exertion spots and they are suitable for a fastened article capable of standing light or medium turning force such that no excessive force is exerted to avoid damaging the fastened article. The polygon head screws provides more force exertion spots and they are very suitable for a fastened article capable of standing medium to heavy turning force such as fastening a machine or a large device.

However, the structure of the preceding screws provide spots for the foreign force exerting a turning force but there is no anti-disengaged device being arranged in the conventional screws.

Taiwanese Patent Official Gazette No. 57450 entitled “ANTI-BURGLAR SCREW LOCK FOR CAR TIRES” discloses an exertion part at the screw head provides a conical contour and converges outward with a slant shape. Further, the screw head has multi-lobed shape or polygon shaped grooves with an identical or different angle between the lobes so as to form various grooves in different sizes corresponding to a specific key element. Hence, only the specific key element is capable of inserting into the screw head and turning the screw. The key element has a sophisticate projection at an end thereof with a configuration corresponding to the grooves in the screw head so that the key element is capable of inserting into the grooves in the screw head. Another end of the key element has a polygon shaped end corresponding to a hexagon head spanner. Due to the arrangement of the screw head and the key element, it is able to reach the purpose of resisting the screw lock being disassembled.

However, the preceding screw lock is tedious in operation for the user because it is required for one end of the key element to insert into the grooves of the screw head and the other end of the key element has to fit with the spanner before the screw head being turned. Further, the screw lock is integrally made and it can be turned for loosening in case of the screw head being clamped slightly with an ordinary fixture. Alternatively, another tool is inserted into the grooves in the key element to create a firm exertion point. Under this circumference, the screw lock is capable of being turned easily too. Thus, once the screw lock can be turned with tools other than the key element, the function resisting being disengaged becomes useless Therefore, it is not proper for the screw lock being applied as a screw locking accessory of an anti-burglar apparatus or security equipment.

### SUMMARY OF THE INVENTION

An object of the present invention is to provide an anti-disengaged screw device with which the force exertion location is changed and only a tool corresponding to the force exertion location is capable of turning the screw head and loosening the screw device.

In order to achieve the preceding object, the anti-engaged screw device according to the present invention comprises a stem member and a nut member. The stem member is a screw rod section connecting with a disk head at an end thereof with a diameter reduced neck section being disposed between the stem member and the disk head. A plurality of exertion wedges are disposed at the disk head to form an exertion location of a foreign torsion force. The nut member is cylindrical with a deep countersink and a bottom axial hole and the deep countersink communicates with the bottom axial hole to receive the disk head and allow the screw rod section passing through the axial hole. A recess ring is formed to surround the axial hole at the lower part of the nut member corresponding to the neck section of the stem member. The recess ring is forced to deform and bend toward the inner wall surface of the axial hole such that the bent part of the recess ring is capable of catching the neck section to secure the stem member to the nut member. Accordingly, a lock configuration is formed between the deep countersink of the nut member and the exertion wedges for being inserted and engaging with a key arm, in which a plurality of wedge recesses with an annular lock head are provided to correspond to the lock configuration. Hence, the stem member is capable of being turned to a state of locking or unlocking with the key arm. Hence, it is capable of preventing the screw device of the present invention from being disengaged by means of an ordinary tool exerting a direct force.

Another object of the present invention is to provide an anti-disengaged screw device in which the stem member is independent of the nut member and to be horizontally rotational attached to the nut member so that it occurs idle rotation of the nut member with respect to the stem member and it is incapable of detaching the screw device of the present invention in case of a clamping tool holding and turning the nut member.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of an anti-disengaged screw device according to the present invention;

FIG. 2 is an exploded and partly sectional perspective view of FIG. 1;

FIG. 3 is an exploded and partly sectional side view of FIG. 2 illustrating the anti-disengaged screw device in the process of assembling;

FIG. 4 is a sectional view illustrating the anti-disengaged screw device being a state of assembling; and

FIG. 5 is a perspective view illustrating the anti-disengaged screw device being applied to a control panel of security equipment.

### DETAILED DESCRIPTION OF THE INVENTION

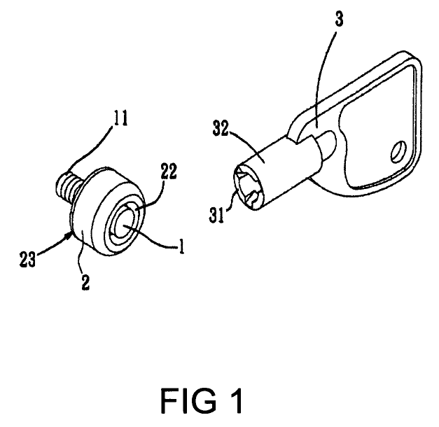

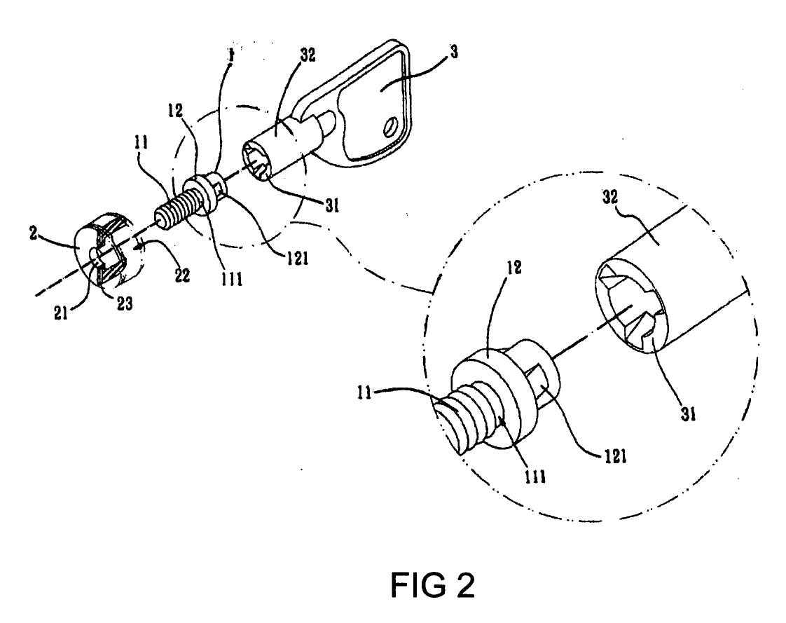

Referring to FIGS. 1 and 2, an anti-engaged screw device according to the present invention comprises a stem member 1 and a nut member 2. The stem member 1 is a screw rod section 11 connecting with a disk head 12 and a diameter reduced neck section 111 in between. A plurality of exertion wedges 121 are disposed at disk head 12 to space apart from each other for a tool inserting into spaces between the exertion wedges 121 and exerting a foreign torsion force against the exertion wedges 121. Preferably, the disk head 12 is provided with a circular periphery for the rotation resulting from torsion being along a circumferential movement.

It is feasibly embodied that the nut member 2 is cylindrical or polygonal prism with a deep countersink 22 and a bottom axial hole 21 and the deep countersink 22 communicates with the bottom axial hole 21. Thus, the disk head 12 is capable of being received in the deep countersink 22 and resting on the bottom of the deep countersink 22 to allow the screw rod section 11 passing through the axial hole 21. Further, a recess ring 23 is formed to surround the axial hole 21 at the lower part of the nut member 2 corresponding to the neck section 111 of the stem member 1.

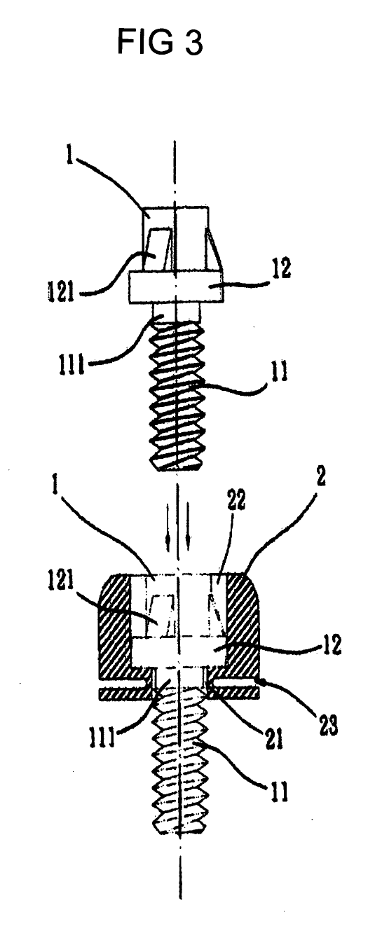

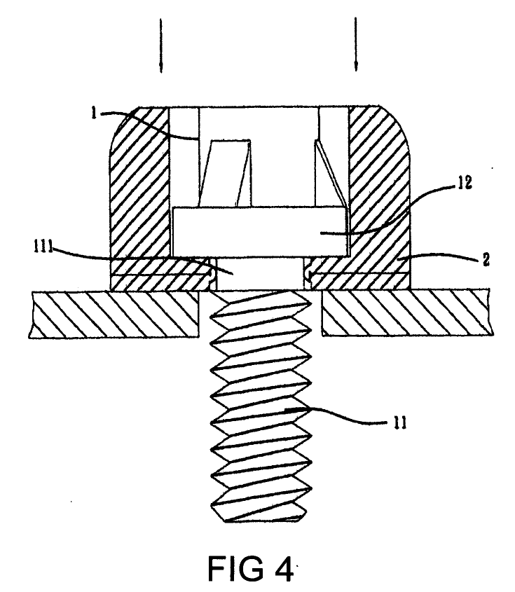

Referring to FIGS. 3 and 4, while the screw device of the present invention is in use, the stem member 1 is inserted into the axial hole 21 with a foreign force evenly by means of such as a press arbor or a pneumatic press device till the top end of the stem member 1 being flush with the top of the nut member 2 as shown in FIG. 4. The recess ring 23 then is forced to deform and bend toward the inner wall surface of the axial hole 21 such that the bent part of the recess ring 23 is capable of catching the neck section 111 of the stem member 1 to secure the screw rod section 11 at the outside the nut member 2 due to the diameter of the screw rod section 11 being larger than the neck section 111. In this way, the stem member 1 is fixedly joined to the nut member 2.

Accordingly, a lock configuration is formed between the deep countersink 22 of the nut member 2 and the exertion wedges 31 for being inserted and engaging with a key arm 3, in which a plurality wedge recesses 31 with an annular lock head 32 are provided to correspond to the lock configuration. Hence, the stem member 1 is capable of being turned to a state of locking or unlocking with the key arm 3.

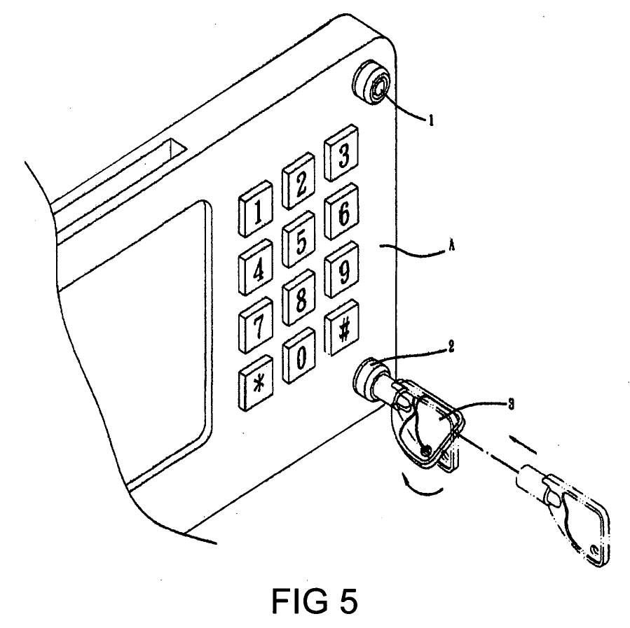

The preceding stem member 1 is designed to be independent of the nut member 2 and to be horizontally rotational attached to the nut member 2 so that it occurs idle rotation of the nut member 2 with respect to the stem member 1 and it is incapable of disassembling the screw device of the present invention in case of a clamping tool holding and turning the nut member 2. An application of the anti-disengaged screw device of the present invention is shown in FIG. 5 and it can be seen that the screw device of the present invention is mounted to a control panel A of secure equipment as a component against being detached.

It is appreciated that the anti-disengaged screw device according to the present invention provides a special screw fastening structure so that it is capable of preventing from being disengaged with ordinary tool exerting direct force.

While the invention has been described with referencing to preferred embodiments thereof, it is to be understood that modifications or variations may be easily made without departing from the spirit of this invention, which is defined by the appended claims.

What is claimed is:

1. An anti-disengaged screw device, comprising
a stem member, being composed of a screw rod section and a disk head and a plurality of exertion wedges being disposed on the disk head as a exertion point of a torsion force; and
a nut member, providing an axial hole and a deep countersink for the screw rod section passing through the axial hole and the disk head being received in the countersink;
wherein, a lock configuration is formed between the circumference of the countersink and the exertion wedges for being inserted and turned with a key arm, which providing wedge recesses and an annular lock head corresponding to the lock configuration.

2. The anti-disengaged screw device as defined in claim 1, wherein a diameter reduced neck section is disposed between the screw rod section and the disk head.

3. The anti-disengaged screw device as defined in claim 1, wherein the disk head provides a circular contour at the periphery thereof.

4. The anti-disengaged screw device as defined in claim 1, wherein the nut member is provided with a cylindrical shape.

5. The anti-disengaged screw device as defined in claim 4, wherein the nut member provides a polygon or a circular periphery.

6. The anti-disengaged screw device as defined in claim 1, wherein a recess ring is formed to surround the axial hole at the lower part of the nut member corresponding to the neck section and is forced to deform and bend toward the inner wall surface of the axial hole so as to catch the stem member.
